(19) United States
(12) Patent Application Publication
(10) Pub. No.: US 2012/0010893 A1
(43) Pub. Date: Jan. 12, 2012

(54) SYSTEM AND METHOD FOR HIGH-PERFORMANCE HANDLING & MASS PROCESSING OF CALCULATION DOCUMENTS

(75) Inventors: Ali Gerhard Tafazzoli-Yazdi, Heidelberg (DE); Banko Bantchev, Stuttgart (DE)

(73) Assignee: SAP AG, Walldorf (DE)

(21) Appl. No.: 12/833,493

(22) Filed: Jul. 9, 2010

(51) Int. Cl. G06Q 99/00

(52) U.S. Cl. 705/1.1

(57) ABSTRACT

Disclosed are embodiments that may provide a system, computer readable medium and a computer-implemented method for calculating gross payment items to provide monetary benefits to a recipient. The disclosed embodiments may include generating an entitlement document for a benefit plan. The entitlement document may contain data indicating the type of benefits to be provided and a plurality of entitlement items that each may include an entitlement amount for an entitlement period. The method may further include calculating due dates for the entitlement periods according to a due date rule, comparing the calculated due dates to a reference date to determine due dates are in the future; and for any entitlement period having a due date in the future, determining whether the entitlement amounts are a constant; and if true, generating a compressed gross payment item (GPI) to represent all future entitlement periods.

### REFERENCE TO RELATED APPLICATION

This application incorporates by reference the entire contents of U.S. Non-Provisional Application Nos. ______ (Atty Docket Nos. 11884/511301, 11884/511401, 11884/511601, 11884/511701, 11884/511801) filed Jul. 9, 2010.

### FIELD

The disclosed subject matter relates to a system and method for handling complex calculations related to providing proper monetary benefits. In particular, the disclosed relates to the high-performance handling and mass process of calculation documents for properly processing payment and provision of benefits.

### BACKGROUND

Modern enterprises such as governmental organizations and private businesses typically use computer systems to manage their operations. Enterprise management systems are computerized systems that define processes and protocols for various business operations. By using enterprise management systems, public and private organizations can define processes that are to be undertaken during performance of the organization's operations which can be applied uniformly among a large set of employees.

In the case of public services providers, an enterprise management system can be used to manage provision of requested services. Conventional payroll applications such as SAP® Payroll solution are not designed for social services management. These payroll applications cannot be integrated naturally with social service functionalities that may require mass payment processing. Moreover, the social services plan may have an entitlement frequency different from the payment frequency. In order to insure accurate distribution of social services benefits, the enterprise business systems may update the status of beneficiaries, the status of applicable laws and regulations including tax changes, status changes resulting from legislation and other aspects of the provided social services that may be subject to change.

When these updates are implemented, the effects of the updates may be to the benefits received by a single person or the entire population of people receiving social services. It becomes very complicated and time consuming to not only identify those affected by the updates, but also perform individual changes to a person's or group of persons social services benefits. Both of these operations may be time consuming and may take a significant amount of time to process. In addition, errors in the amounts of social service benefits provided may result in either a significant amount of either overpayment or underpayment of benefits which wastes resources and may adversely affect social service recipients.

Existing systems that handle or transform entitlements into payments are typically confronted with critical performance and data volume problems. For example, a social service (e.g., pensions) is provided to a huge number of citizens for a long time (e.g., open-ended); and payments need to be periodically recalculated. Accordingly, a need exists for a method and system for efficiently the high-performance calculation and mass process of payment documents, and for proper management of payments provided to the recipients.

### BRIEF DESCRIPTION OF THE DRAWINGS

FIG. 1 illustrates an exemplary document generation process according to an embodiment.

FIG. 2 illustrates an exemplary gross payment document according to an exemplary embodiment.

FIG. 3 illustrates an exemplary process flow according to an embodiment.

FIG. 4 illustrates an exemplary process flow for calculating gross payment amounts with an existing overlapping gross payment item (GPI) according to an embodiment.

FIG. 5 illustrates an exemplary process for compression of future gross payment items (GPIs) according to an exemplary embodiment.

FIG. 6 illustrates an exemplary GPI according to an exemplary embodiment.

FIG. 7 illustrates an exemplary computer system for implementing a social services system according to an embodiment.

### DETAILED DESCRIPTION

System and method for handling complex calculations in the management of monetary benefits are presented. Embodiments of the present invention provide a computer-implemented method for calculating gross payment items to provide social service benefits to a recipient. The method may include generating, using a computer processor of a back end of the computer system, an entitlement document for a social services plan. The generated entitlement document may contain data indicating the type of benefits to be provided by the social services plan and a plurality of entitlement items. Each entitlement item may include an entitlement amount for an entitlement period. The method may further include calculating due dates for entitlement periods according to a due date rule, comparing the calculated due dates to a reference date to determine whether any entitlement period has a due date in the future; and for any entitlement period having a due date in the future, determining whether all future the entitlement amounts are a constant; and if the future entitlement amounts are a constant, generating a compressed gross payment item (GPI) to represent all future entitlement periods.

Social services are commonly provided by governmental agencies in cooperation with service providing partners, such as private food pantries, soup kitchens, government-run health facilities, or private healthcare providers. The provision of social services, or simply benefits, is typically accomplished according to a social services plan developed for the requestor. For example, a requestor may be temporarily out of work and may need food stamps to feed his children and medical coverage for himself and his family, while another requestor may be homeless and need access to a shelter, clothing and food. Due to their circumstances, these two requestors may have differing status and, as a result, may require different plans for coordinating the benefits provided to each. The government social services office or department may formulate different social services plans for each of the requestors. Once the social services plan is developed (and approved), it may be implemented.

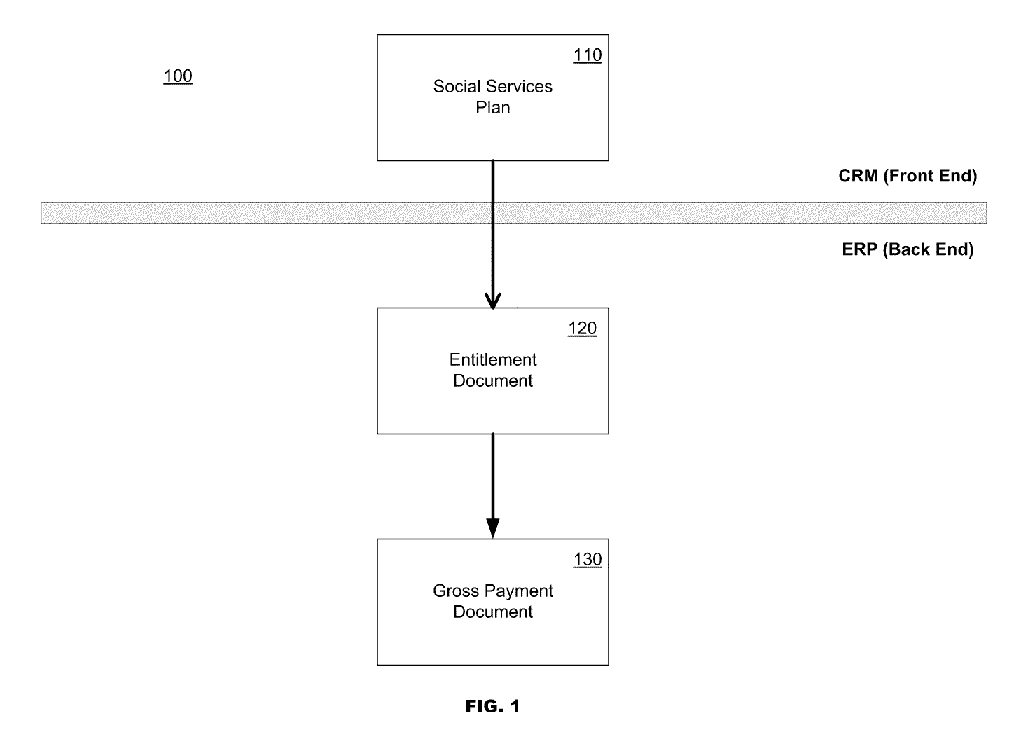

In order to manage the provision of the social services benefits, a number of electronic documents may be generated. The document generation flow after approval of a social services plan for a recipient will be described in more detail with reference to FIG. 1. FIG. 1 illustrates an exemplary document generation process according to an embodiment. For example, using a client computer at a front end of a computer system, a social services requestor/recipient may fill out an application requesting social service benefits, and begin the document generation process 100. Upon approval of the social services benefit request, a social services plan 110 may be created at the front end of the computer system. The social services plan 110 may be populated with data items. The data items in the social services plan 110 may include data such as, a unique identifier of the social services plan 110 or the requestor/recipient, the benefits to be provided (i.e., benefit scenario), identity of business partners that will be implementing the benefits scenario, the decision period (i.e., how long the benefits will last at the present levels), and header information. The unique identifier may be a case assignment number or some other indicator of the recipient related to the social services plan 110. The front end system such as a CRM system may release the data of the social services plan. The data is transferred from CRM to ERP using a remote function call. The remote function call may include, for example, the identity of the new social services plan 110 and the identity of programs for which the recipient has been approved. Upon release in the CRM, the back end ERP system may use the data of the social services plan 110 to generate entitlement data items of the entitlement items document comprising monetary amounts for the services indicated in the social services plan.

The generated entitlement document 120 may store the calculated monetary amounts of benefits for each of the social services identified in the social services plan 110 for the recipient. In addition to monetary amounts, the entitlement data items in the entitlement document 120 may also include data replicated from the social services plan 110 data items in the front end CRM application. The replicated data in the entitlement document 120 may include some or all of the data included in the social services plan 110. In addition, entitlement data items may be generated that include additional data, for example, a lifetime maximum benefit amount, related to entitlements for specific services.

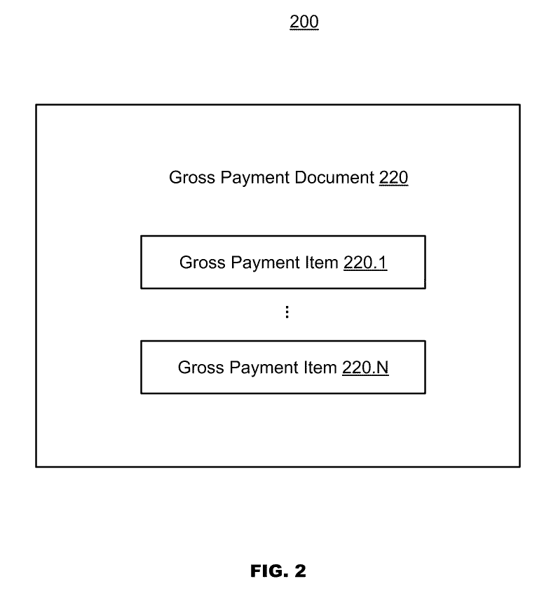

Specific service entitlements may include monetary values, for example, for a housing allowance, a food stamps allowance, a medical services allowance, a clothing allowance, and other monetary social service benefits allowances. The monetary value of specific service entitlements may be established according to current customizable rule sets as applied to the particular requestor's social services plan. Once the entitlement data items in the entitlement document 120 have been populated, the entitlement document 120 may be released. Upon release of the entitlement document, the front end CRM system may send data in the entitlement document 120 using, for example, a remote function call to the back end ERP system. The back end ERP system may calculate gross monetary payments that are due to the recipient. The retrieved data may be incorporated into a gross payment document 130 by back end ERP system. In addition, results from the calculations of the gross monetary payments performed by back end ERP system may be stored as data items in the gross payment document 130. The entitled monetary values stored in the gross payment items may represent payment amounts prior to taxes, deductions and other factors that may reduce the payment. The content of the gross payment document 130 will be explained in more detail with reference to FIG. 2. It should be noted that although the exemplary embodiments are explained with a social services plan, the social services plan may represent any monetary benefit plans, such as, for example, pension plans run by a private company, insurance plans administered by an insurance company.

FIG. 2 illustrates a detailed example of the exemplary gross payment document 130 illustrated in FIG. 1. As shown in FIG. 2, the gross payment document 130 may comprise a plurality of gross payment items 210.1 to 210.N. N may be an integer number greater than one. In one embodiment, a gross payment item may be generated for a gross payment amount that is related to one entitlement item (ECR), one benefit, one benefit beneficiary, one payment recipient and one entitlement frequency period. Thus, N may represent number of frequency periods covered by a gross payment document and corresponding entitlement document. One gross payment item per entitlement frequency period may be a high granularity and may ensure a one to one relationship between gross payment items to entitlement items. This may be especially useful, because entitlement attributes may be unambiguously related to GPIs. In addition, later splits of GPIs during calculation may be prevented, because entitlement frequency periods are the smallest portion of time period. Further, older GPIs that have already been calculated but not yet paid out may be stopped for each GPI as a whole. For example, a gross payment item with a future due date (relative to a reference date to be described below) may be calculated for a payment period, and later a new gross payment item may be calculated to replace the older GPI. The existing gross payment item may be rendered obsolete and stopped. This may be referred to as “delimited.”

The gross payment document 130 may be part of the payment view on entitlements. For example, the gross payment document 130 may be created by adding payment information and by considering past payments. The gross payment amount contained in each gross payment item may be determined by a comparison between a current entitlement amount of an entitlement item against all already executed payment amounts for this entitlement item. In one embodiment, all previously existing gross payment items with a due date earlier than a reference date (to be described below) may be regarded as already executed.

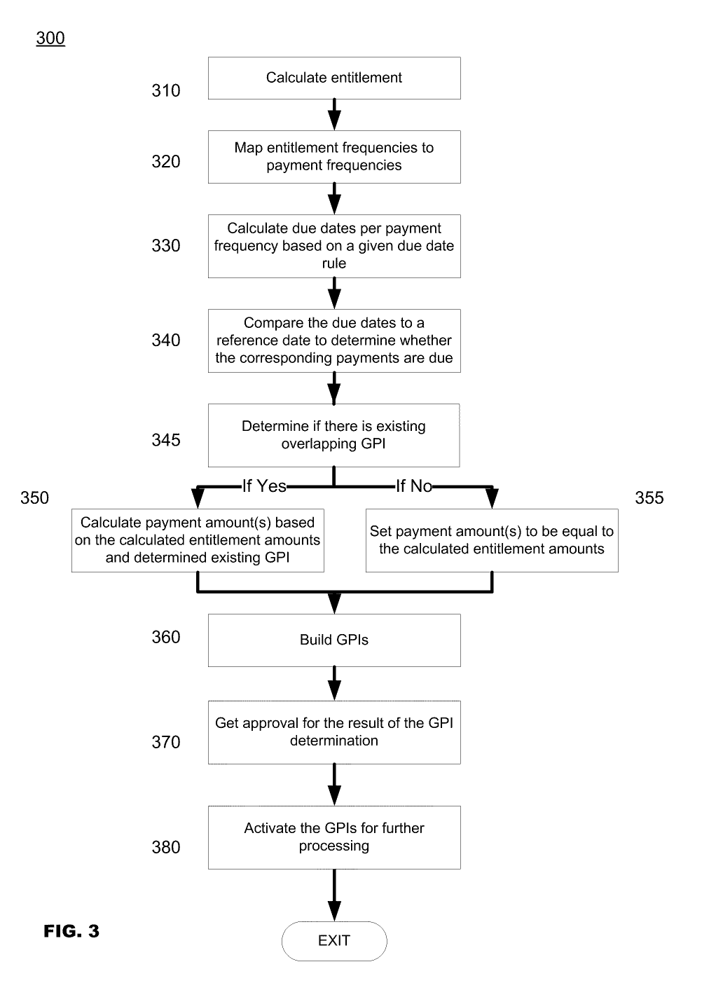

FIG. 3 illustrates an exemplary process flow 300 for gross payment item determination according to an embodiment. In at least one embodiment, the exemplary process 300 may be performed by a computer processor at a back end ERP system. At step 310, for example, the recipient's entitlement may be calculated. The calculated entitlement may be stored in entitlement document 120 as shown in FIG. 1 and described above. The calculation may be performed for an entitlement calculation period (ECR) that spans multiple entitlement periods. The ECR may be a fixed time period (e.g., three months, one year) or open-ended (e.g., as long as a senior citizen is alive). At step 320, the entitlement frequencies may be mapped to payment frequencies. For example, entitlement frequency for social services may be based on government regulations and or rules (e.g., weekly, bi-weekly, or monthly), the payment frequency may be different (e.g., several weekly entitlements may be combined to generate a monthly payment). Correspondingly, a payment period may cover one entitlement period or a plurality of entitlement periods and include fractions of entitlement periods. The entitlement frequency may be changed by government and the payment frequency also may be adjustable (e.g., by a case administrator). As described above with respect to FIG. 2, in one embodiment, a gross payment item may be generated for one entitlement item, and thus has a gross payment amount corresponding to the entitlement amount for one entitlement period. In at least one embodiment, a payment period may be the same as an entitlement period, and thus each payment amount may be determined by one gross payment item that corresponds to an entitlement item. In another embodiment, a payment period may span multiple entitlement periods and fractions of entitlement periods. For example, the payment period may be a month and an entitlement period may be a week. Thus, each payment period may span several weeks and include fractions of a week at the beginning or end of the month.

At step 330, the process flow 300 may calculate due dates for each payment frequency. The due dates may be calculated by based on a user defined due date rule (e.g., first day of the month, or every other Friday). In one embodiment, a due date rule may be specified by a modifier and a day offset. The modifier may be a relative time point (e.g., being or end) related to a provided time period (e.g., a week or a month), or a more absolute time point (e.g., the calculation date). Then at step 340, the calculated due dates may be compared to a reference date to determine whether corresponding payments are due. The reference date may also be determined by use of the due date rule and may be adjusted/set by a plan administrator. For example, the reference date may be customized to a modifier, for example, “today” or “decision of the related social service plan,” depending on the actual plan-type. Further, an offset may be applied to the modifier to determine the reference date.

At step 345, the process flow 300 may determine whether there are existing overlapping GPIs. Any existing GPIs may be stored in a data storage, such as a database. The data storage may be searched by certain criteria, for example, same payment beneficiary, same social services plan, and overlapping benefit period. The existing overlapping GPIs may be determined from existing GPIs that match the criteria. If there is no overlapping GPI, the process flow 300 may set the payment amounts to be equal to the calculated entitlement amounts at step 355. Alternatively, when it is determined that there are existing overlapping GPIs, the process flow 300 may calculate a payment amount for each entitlement period based on the entitlement amount and the existing GPIs. Then, at step 360, the process flow 300 may generate gross payment items for regular payments. The newly generated gross payment items may be grouped together into one gross payment document as shown in FIG. 2. The gross payment document and the gross payment items may be stored in memory and further into databases. After building the gross payment items, the process flow 300 may submit the result of the gross payment item determination for approval for at step 380. In one embodiment, the result may be submitted in an email to a plan administrator. At step 390, once approved, the generated gross payment items may be activated for further processing. For example, deductions may be applied to the gross payments and checks may be prepared for the net payment amounts after deductions are applied.

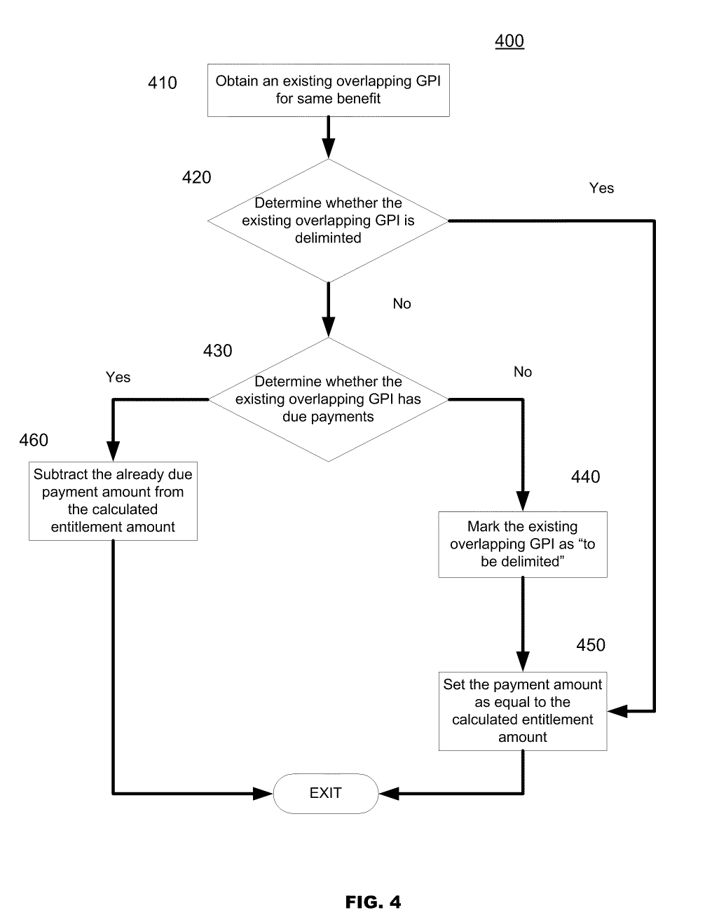

The processing of existing overlapping GPIs may affect the payment amounts in the newly generated gross payment items, and will be explained in more detail with reference to FIG. 4. In at least one embodiment, the exemplary process 400 may be performed by a computer processor at a back end ERP system. FIG. 4 illustrates an exemplary process 400 for calculating gross payment amounts with an existing overlapping gross payment item (GPI) according to an embodiment. At step 410, the exemplary process 400 may obtain an existing GPI for a gross payment item. The existing GPI may have a same benefit period for a same benefit and same beneficiary. At step 420, the exemplary process 400 may determine whether the existing overlapping GPI is delimited. For example, the existing overlapping GPI may has been determined to be obsolete and rendered as stopped from being paid. If yes, the process flow 400 may proceed to step 450, in which the payment amount may be set to be equal to the calculated entitlement amount for the entitlement period. Otherwise, if the existing overlapping GPI is not delimited, the exemplary process 400 may proceed to step 430, in which, the exemplary process 400 may determine whether the existing overlapping GPI has due payments. If it is determined that the existing overlapping GPI has a payment already due, then exemplary process 400 may proceed to step 440, in which, the existing overlapping GPI may be marked as “to be delimited.” Then, the exemplary process 400 may proceed to step 450. Otherwise, if it is determined that the existing overlapping GPI does not have a payment already due, the exemplary process 400 may proceed from step 430 to step 460, in which, the exemplary process 400 may subtract the already due payment amount from the calculated entitlement amount. After either the step 450 or 460, the exemplary process 400 may exit back to process 300 for execution of step 360.

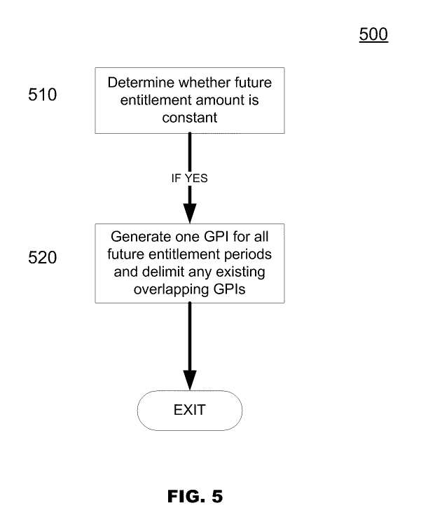

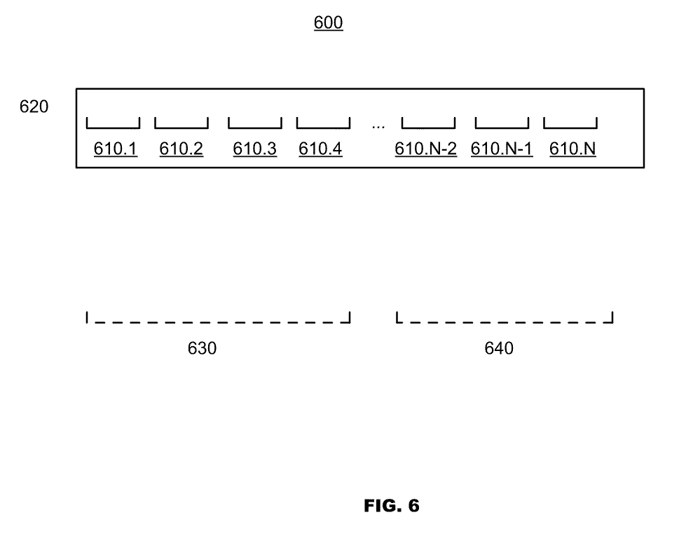

In another embodiment, future GPIs may be compressed to respond to efficiency needs. Compression of GPIs will be explained in more detail with reference to FIGS. 5 and 6. FIG. 5 illustrates an exemplary process 500 for compression of future gross payment items (GPIs) according to another exemplary embodiment. In at least one embodiment, the exemplary process 500 may be performed by a computer processor at a back end ERP system. If any of the due dates are determined to in the future at step 340, the process 500 may be implemented. At step 510, the process 500 may determine whether the future entitlement amount is constant for all future entitlement periods. If not, the process 500 exits and GPIs may be generated according to the process 300. If yes, the process 500 may proceed to step 520, in which a single GPI for all future entitlement periods may be generated. In one or more embodiments, the process 500 may search a database storing existing GPIs for any existing GPIs that have entitlement periods overlapping with the single GPI's coverage. The search may be performed for certain criteria, for example, same payment beneficiary, same social services plan, and overlapping benefit period. Any existing GPI that matches the search criteria may be delimited.

Future GPIs may need a vast amount of computation because future entitlement to a social services plan may be open-ended or last a long term. Thus, the exemplary process 500 shows a compression for future GPIs. While the exemplary process 300 may be applied to generate both future and past GPIs. The exemplary process 500 may also be applied to past GPIs. However, applying the exemplary process 500 to future GPIs may have a higher performance.

FIG. 6 illustrates an exemplary GPI according to an exemplary embodiment. As shown in FIG. 6, a plurality of entitlement periods 610.1˜610.N may each have a constant future entitlement amount. A single GPI 620 may be generated that represents all future gross payments. In one embodiment, the first entitlement period with a due date after a reference date may be identified. The begin of the first entitlement period may be the begin of all future entitlement periods and the compressed GPI may be generated for the first entitlement period. Because the entitlement amount is a constant value for all future entitlement periods, the compressed GPI may represent all future entitlement periods. The dashed periods 630 and 640 may represent actual payment periods. By generating one GPI spanning a time period that may be as long as the underlying entitlement amount is constant, the computation efficiency may be improved. Payment information may be represented without losing any information. Further, as shown in FIG. 6, dashed periods 630 and 640 may cover different entitlement periods. By one GPI that corresponds to a constant entitlement amount, embodiments of process 500 may avoid generating more complex GPIs for different actual gross payment amounts for each actual payment period. In one or more embodiments, necessary data, such as, but not limited to, payment amount, payment period, may be derived dynamically if needed.

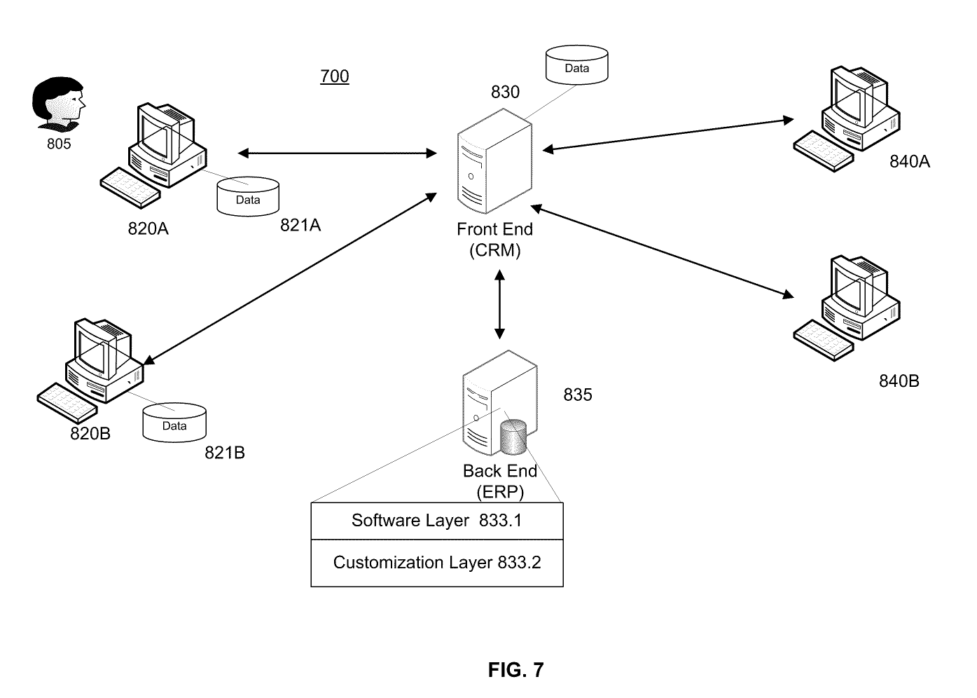

FIG. 7 illustrates an exemplary computer system 700 for implementing a social services system. The system 700 may comprise a plurality of clients 820A and 820B, a front end server 830, a backend server 835, and a plurality of service partners 840A and 840B. Each client 820A-B may include a client computer 821A-B or, simply, be a terminal connected to the frontend server 830. A requestor/recipient 805 may provide information to the client 820A identifying the benefit(s), e.g., food stamps, meal tickets, healthcare, transportation, shelter and the like, the requestor/recipient 805 wishes to receive. According to software embodied on a storage device within any of computer 820A, a data storage 821A, or on server 830, a social service plan may be generated based on electronic forms provided to the client 820A from either computer 821A or front end server 830. However, each of clients 820A-B may be located in a different jurisdictions, such as a different country, or, if in the United States, in a different state, or county within a state, all of which may have different eligibility requirements for obtaining services and different approval rules for granting approval of the requested services. Therefore, the front end server 830 may provide a customized rule set retrieved from a data storage to generate the correct social services plan for the requester. Front end server 830 may execute a customer relationship management (CRM) application via the clients 820A or 820B to facilitate the requesting and approving process for the requestor/recipient 805. The front end server 830 may also communicate with a back end server 835 that may also, or instead of front end server 830, maintain the customized rule sets applicable to the different evaluations performed in the process. Of course, the customized rule sets may be distributed between the front end server 830 and the back end server 835.

The front end server 830 or the back end server 835 may include a software layer 833.1 that implements a social services computer application and a customization layer 833.2 that implements customized rule sets for each jurisdiction. An exemplary software architecture of the software layer 833.1 may include a basic application framework that facilitates the creation of a social services plan and computer executable instructions for generation of the explained entitlement item documents, the payment item documents and calculation of the net payments due to the recipient. At various stages of the application process, the software layer 833.1 may make calls to the customization layer 833.2. The customization layer 833.2 may be generated according to local rules that affect the application process. The instructions in the software layer 833.1 may cause a processor to implement functions stored within the customization layer 833.2, such as customizable rule sets for how a recipient may be paid according to the SSP, EID and PID.

The customization layer 833.2 may be developed and maintained by the end user. This allows the end user to modify any rules sets as changes occur in the criteria related to the payment of the services. In addition, as new services are provided, the end user may generate rule sets that are called by the software layer 833.1. The social services agency, or end user, that is accepting, processing according to the described exemplary methods, and/or approving the applications may use rule engines, as known in the computer science field and provided by vendors such as SAP® and the like, to customize the rule sets in the customization layer 420. Alternatively to using a rules engine, the customized rule sets in customization layer 833.2 may be formulated and generated by hard coded, or developed in some other manner.

When the social services plan is completed and approved for the requestor/recipient 805, electronic documents incorporating data items may be generated to provide the details of the services that comprise the social services plan for the requestor/recipient 805. The data items within the social services plan may be used by the CRM application to generate an entitlement items document. The entitlement items document may comprise current data items indicating the type of benefits to be provided, dates on which the benefits are due to be provided, and the amount of benefits the recipient is entitled.

The exemplary method and computer program instructions may be embodied on a machine readable storage medium such as a computer disc, optically-readable media, magnetic media, hard drives, RAID storage device, and flash memory. In addition, a server or database server may include machine readable media configured to store machine executable program instructions. The features of the embodiments of the present invention may be implemented in hardware, software, firmware, or a combination thereof and utilized in systems, subsystems, components or subcomponents thereof. When implemented in software, the elements of the invention are programs or the code segments used to perform the necessary tasks. The program or code segments can be stored on machine readable storage media. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device. The code segments may be downloaded via computer networks such as Internet, Intranet, etc.

Although the invention has been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. The operation processes are also not limited to those shown in the examples. Those skilled in the art will appreciate that the invention may be implemented in other ways without departing from the spirit and substantive features of the invention. For example, features and embodiments described above may be combined with and without each other. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A computer-implemented method for calculating gross payment items to provide monetary benefits to a recipient, comprising:
generating, using a computer processor of a back end of the computer system, an entitlement document for a benefit plan, the entitlement document containing data indicating the type of benefits to be provided by the benefit plan and a plurality of entitlement items, each entitlement item including an entitlement amount for an entitlement period;
calculating due dates for entitlement periods according to a due date rule;
comparing the calculated due dates to a reference date to determine whether any entitlement period has a due date in the future;
for any entitlement period having a due date in the future, determining whether all future entitlement amounts are constant; and
if the future entitlement amounts are constant, compressing data for future entitlement periods to a compressed gross payment item (GPI) to represent all future entitlement periods.

2. The method of claim 1, wherein an actual payment period covers a plurality of entitlement periods.

3. The method of claim 2, wherein an actual gross payment for the actual payment period is derived dynamically.

4. The method of claim 2, wherein the actual payment period is derived dynamically.

5. The method of claim 4, wherein the reference date is also determined by the due date rule.

6. The method of claim 1, wherein the reference date is an arbitrary reference date for a background job.

7. A computer system for providing and managing monetary benefits, comprising:
a plurality of client computers at a front end of the computer system; and
a backend server connected to the plurality of client computers, the server including a processor and a connection to a database, the processor configured to execute computer program instructions to:
generate an entitlement document for a benefit plan, the entitlement document containing data indicating the type of benefits to be provided by the benefit plan and a plurality of entitlement items, each entitlement item including an entitlement amount for an entitlement period;
calculate due dates for entitlement periods according to a due date rule;
compare the calculated due dates to a reference date to determine whether any entitlement period has a due date in the future;
for any entitlement period having a due date in the future, determine whether all future entitlement amounts are constant; and
if the future entitlement amounts are constant, compress data for future entitlement periods to a compressed gross payment item (GPI) to represent all future entitlement periods.

8. The computer system of claim 7, wherein an actual payment period covers a plurality of entitlement periods.

9. The computer system of claim 8, wherein an actual gross payment for the actual payment period is derived dynamically.

10. The computer system of claim 8, wherein the actual payment period is derived dynamically.

11. The computer system of claim 10, wherein the reference date is also determined by the due date rule.

12. The computer system of claim 7, wherein the reference date is an arbitrary reference date for a background job.

13. A computer-readable medium embodied with program instructions for causing a computer to execute a method for calculating gross payment items to provide monetary benefits to a recipient, the method comprising:
generating an entitlement document for a benefit plan, the entitlement document containing data indicating the type of benefits to be provided by the benefit plan and a plurality of entitlement items, each entitlement item including an entitlement amount for an entitlement period;
calculating due dates for entitlement periods according to a due date rule;
comparing the calculated due dates to a reference date to determine whether any entitlement period has a due date in the future;
for any entitlement period having a due date in the future, determining whether all future entitlement amounts are constant; and
if the future entitlement amounts are constant, compressing data for future entitlement periods to a compressed gross payment item (GPI) to represent all future entitlement periods.

14. The computer-readable medium of claim 13, wherein an actual payment period covers a plurality of entitlement periods.

15. The computer-readable medium of claim 14, wherein an actual gross payment for the actual payment period is derived dynamically.

16. The computer-readable medium of claim 14, wherein the actual payment period is derived dynamically.

17. The computer-readable medium of claim 16, wherein the reference date is also determined by the due date rule.

18. The computer-readable medium of claim 13, wherein the reference date is an arbitrary reference date for a background job.
